(19) United States
(12) Patent Application Publication
(10) Pub. No.: US 2016/0259325 A1
(43) Pub. Date: Sep. 8, 2016

(54) APPARATUS AND METHOD FOR MODELLING THREE DIMENSIONAL SHAPE

(71) Applicants: SAMSUNG SDS CO., LTD., Seoul (KR); Industry-University Cooperation Foundation Hanyang University, Seoul (KR)

(72) Inventors: Nak-Yong YANG, Suwon-si (KR); Min-Sik CHU, Seoul (KR); Dong-Hoon CHOI, Seoul (KR); Kyu-Byung PARK, Seoul (KR)

(73) Assignees: SAMSUNG SDS CO., LTD., Seoul (KR); Industry-University Cooperation Foundation Hanyang University, Seoul (KR)

(21) Appl. No.: 15/061,258

(22) Filed: Mar. 4, 2016

(30) Foreign Application Priority Data
Mar. 6, 2015 (KR) 10-2015-0031858

(51) Int. Cl. G05B 19/4099; G06T 19/20

(52) U.S. Cl. CPC G05B 19/4099; G06T 19/20; G05B 2219/49023

(57) ABSTRACT

Disclosed are an apparatus and method for modeling a three-dimensional (3D) shape. The apparatus for modeling a 3D shape includes a stacker configured to generate a skinned 3D model by forming an empty space inside a target 3D model and stack a plurality of 3D unit objects in the empty space; an influence calculator configured to calculate an influence of a change in a characteristic value of each of the plurality of 3D unit objects on mechanical properties of the target 3D model; a grouper configured to group the plurality of 3D unit objects into a plurality of groups according to the calculated influence; and a characteristic value calculator configured to determine an optimal characteristic value of the 3D unit object for each of the plurality of groups.

### CROSS-REFERENCE TO RELATED APPLICATION

This application claims priority to and the benefit of Korean Patent Application No. 10-2015-0031858, filed on Mar. 6, 2015, the disclosure of which is incorporated herein by reference in its entirety.

### BACKGROUND

1. Field

Embodiments of the present disclosure relate to technology for modeling a three-dimensional (3D) shape in order to manufacture a 3D object.

2. Discussion of Related Art 3D printing refers to manufacturing technology for synthesizing a 3D object by stacking materials of continuous layers.

In initial 3D printing technology, when a 3D object, which is an output object, is manufactured, the interior of the 3D object is fully filled. However, in order to fill the interior of the 3D object, too many materials are consumed, and also the weight of the 3D object increases. Accordingly, a printing scheme in which the interior of the 3D object is emptied out or partially stacked has been proposed. However, when the interior of the 3D object is excessively emptied, mechanical properties such as tensile strength, compressive strength, or the like of the 3D object are affected, and thus a means for optimizing an internal structure of a 3D model is needed.

### SUMMARY

Embodiments of the present disclosure are directed to a means for optimizing an internal structure of a 3D model used to manufacture a 3D object in consideration of mechanical properties of the 3D model.

Embodiments of the present disclosure are also directed to a means for effectively shortening a processing time for optimizing an internal structure of the 3D model.

According to an aspect of the present disclosure, there is a method of modeling a three-dimensional (3D) shape, the method including generating a skinned 3D model by forming an empty space inside a target 3D model; stacking a plurality of 3D unit objects in the empty space; calculating an influence of a change in a characteristic value of each of the plurality of 3D unit objects on mechanical properties of the target 3D model; grouping the plurality of 3D unit objects into a plurality of groups according to the calculated influence; and calculating an optimal characteristic value of the 3D unit object for each of the plurality of groups.

The generating of the skinned 3D model may include forming the empty space by forming an outer wall with a predetermined thickness based on an external surface of the target 3D model and deleting an interior of the outer wall.

The stacking may include stacking the plurality of 3D unit objects such that adjacent 3D unit objects overlap by a predetermined distance or an outer wall of the skinned 3D model and a 3D unit object adjacent to the outer wall overlap by a predetermined distance.

The mechanical properties of the target 3D model may be any one of tensile strength, compressive strength, yield stress, elongation, fatigue strength, impact value, elasticity, heat transfer rate, thermal reliability, fatigue resistance, flow efficiency, and hardness of the 3D model.

The calculating of the influence may further include obtaining a simulation result of the change in the characteristic value of each 3D unit object using an experimental design method in which the characteristic value of the 3D unit object is utilized as a design variable; and calculating an influence on the mechanical properties of the target 3D model through a regression analysis for the simulation result.

The obtaining of the simulation result may include using an optimal Latin hypercube design (OLHD) method to obtain the simulation result.

The grouping may include normalizing the influence into a predetermined range and grouping the plurality of 3D unit objects into the plurality of groups according to the normalized influence.

The characteristic value of the 3D unit object may be any one of a diameter of each object constituting the 3D unit object, the number of objects formed in the 3D unit object, and a density of material of which the 3D unit object is made.

The calculating of the optimal characteristic value may include determining the optimal characteristic value such that characteristic values of 3D unit objects belonging to the same group are the same.

The calculating of the optimal characteristic value may include determining the optimal characteristic value of the 3D unit object for each of the plurality of groups such that a volume of the target 3D model is minimized while the mechanical properties of the target 3D model are maintained at a predetermined level or higher.

According to another aspect of the present disclosure, there is a computer program stored in a recording medium that is combined with hardware and configured to execute a method, the method including generating a skinned 3D model by forming an empty space inside a target 3D model; stacking a plurality of 3D unit objects in the empty space; calculating an influence of a change in a characteristic value of each of the plurality of 3D unit objects on mechanical properties of the target 3D model; grouping the plurality of 3D unit objects into a plurality of groups according to the calculated influence; and calculating an optimal characteristic value of the 3D unit object for each of the plurality of groups.

According to still another aspect of the present disclosure, there is an apparatus for modeling a three-dimensional (3D) shape, the apparatus including a stacker configured to generate a skinned 3D model by forming an empty space inside a target 3D model and stack a plurality of 3D unit objects in the empty space; an influence calculator configured to calculate an influence of a change in a characteristic value of each of the plurality of 3D unit objects on mechanical properties of the target 3D model; a grouper configured to group the plurality of 3D unit objects into a plurality of groups according to the calculated influence; and a characteristic value calculator configured to determine an optimal characteristic value of the 3D unit object for each of the plurality of groups.

The stacker may form the empty space by forming an outer wall with a predetermined thickness based on an external surface of the target 3D model and deleting an interior of the outer wall.

The stacker may stack the plurality of 3D unit objects such that adjacent 3D unit objects overlap by a predetermined distance or an outer wall of the skinned 3D model and a 3D unit object adjacent to the outer wall overlap by a predetermined distance.

The mechanical properties of the target 3D model may be any one of tensile strength, compressive strength, yield stress, elongation, fatigue strength, impact value, elasticity, heat transfer rate, thermal reliability, fatigue resistance, flow efficiency, and hardness of the 3D model.

The influence calculator may obtain a simulation result of the change in the characteristic value of each 3D unit object using an experimental design method in which the characteristic value of the 3D unit object is utilized as a design variable and may calculate an influence on the mechanical properties of the target 3D model through a regression analysis for the simulation result.

The influence calculator may obtain the simulation result using the optimal Latin hypercube design (OLHD) method.

The grouper may normalize the influence into a predetermined range and may group the plurality of 3D unit objects into the plurality of groups according to the normalized influence.

The characteristic value of the 3D unit object may be any one of a diameter of each object constituting the 3D unit object, the number of objects formed in the 3D unit object, and a density of material of which the 3D unit object is made.

The characteristic value calculator may determine the optimal characteristic value such that characteristic values of 3D unit objects belonging to the same group are the same.

The characteristic value calculator may determine the optimal characteristic value of the 3D unit object for each of the plurality of groups such that a volume of the target 3D model is minimized while the mechanical properties of the target 3D model are maintained at a predetermined level or higher.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a block diagram for describing an apparatus for modeling a 3D shape according to an embodiment of the present disclosure;

FIG. 2 is an exemplary diagram illustrating a target 3D model;

FIG. 3 is an exemplary diagram for describing an example in which the apparatus for modeling a 3D shape generates a skinned 3D model from the target 3D model shown in FIG. 2, according to an embodiment of the present disclosure;

FIG. 4 is an exemplary diagram illustrating a 3D unit object according to an embodiment of the present disclosure;

FIG. 5 is an exemplary diagram showing an example in which the 3D unit object shown in FIG. 4 is stacked inside the skinned 3D model shown in FIG. 3;

FIG. 6 is an exemplary diagram for describing an example in which 3D unit objects are stacked by a stacker to overlap each other according to an embodiment of the present disclosure; and

FIG. 7 is a flowchart for describing a method of modeling a 3D shape according to an embodiment of the present disclosure.

### DETAILED DESCRIPTION OF EXEMPLARY EMBODIMENTS

Hereinafter, embodiments of the present disclosure will be described in detail with reference to the accompanying drawings. The following detailed description will be provided for better understanding of a method, an apparatus, and/or a system that are disclosed in this specification. However, this is merely exemplary, and the present disclosure is not limited thereto.

In describing embodiments of the present disclosure, when it is determined that detailed description of known techniques associated with the present disclosure would unnecessarily obscure the gist of the present disclosure, the detailed description thereof will be omitted. Also, the terms described below are defined in consideration of the functions in the present disclosure, and thus may vary depending on a user, intention of an operator, or custom. Accordingly, the terms will be defined based on the whole specification. The terminology used herein is for the purpose of only describing embodiments of the present disclosure, and should not be restrictive. The singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

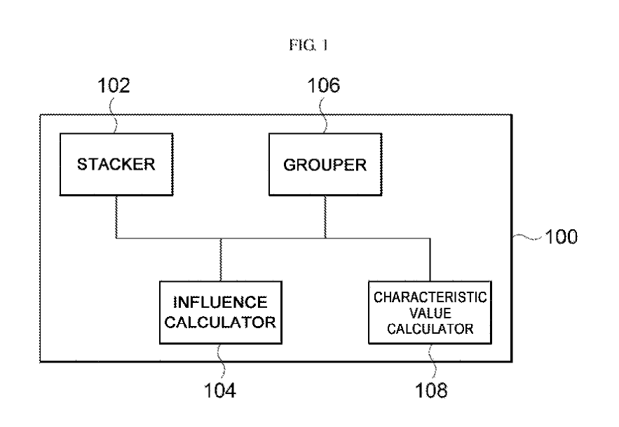

FIG. 1 is a block diagram for describing an apparatus 100 for modeling a 3D shape according to an embodiment of the present disclosure. As shown, the apparatus 100 for modeling a 3D shape according to an embodiment of the present disclosure includes a stacker 102, an influence calculator 104, a grouper 106, and a characteristic value calculator 108.

The stacker 102 is configured to generate a skinned 3D model by forming an empty space inside an input target 3D model and stack a plurality of 3D unit objects in the formed empty space.

According to an embodiment, the target 3D model is a model that is used for a 3D printer to manufacture a 3D object and may have a form such as, for example, a CAD format or a Standard Tessellation Language (STL) format. However, embodiments of the present disclosure are not limited to a 3D model having a specific form.

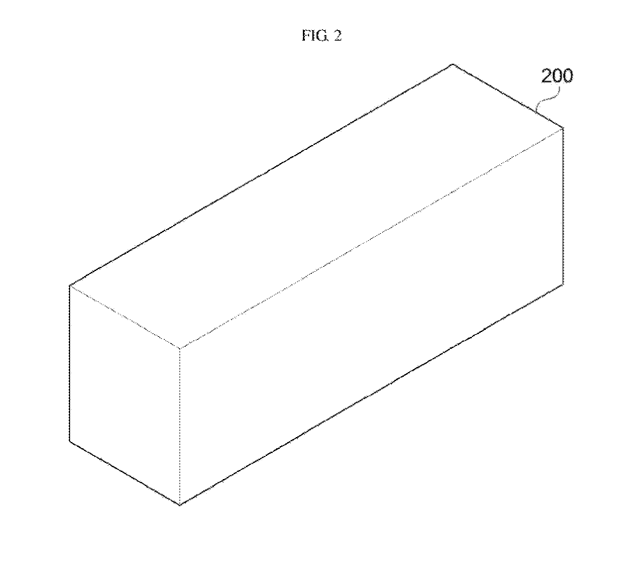

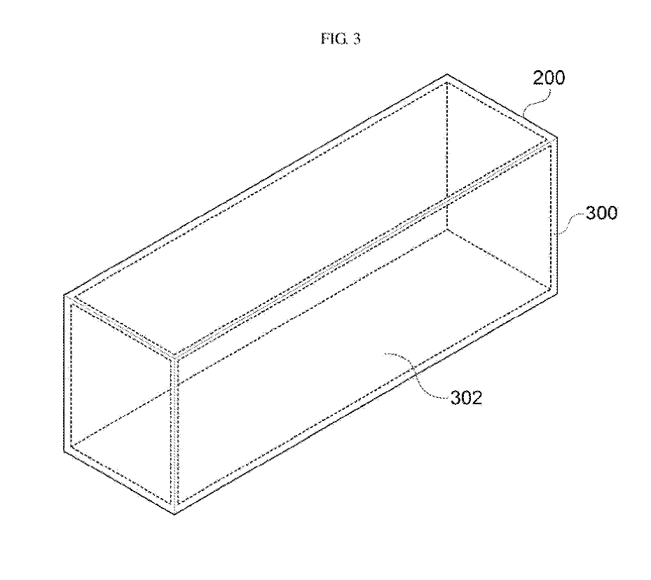

The stacker 102 may form the empty space by forming an outer wall with a predetermined thickness on the basis of an external surface of the target 3D model and deleting the interior of the outer wall. For example, when there is a target 3D model 200 as shown in FIG. 2, the stacker 102 may form an empty space 302 in the target 3D model by remaining an outer wall 300 having a certain thickness and deleting the interior of the target 3D model as shown in FIG. 3. Here, the thickness of the outer wall 300 may be appropriately determined in consideration of the size of the target 3D model or the quality of the 3D object that is to be formed from the target 3D model.

When the empty space is formed inside the 3D model as described above, the stacker 102 stacks the plurality of 3D unit objects in the empty space.

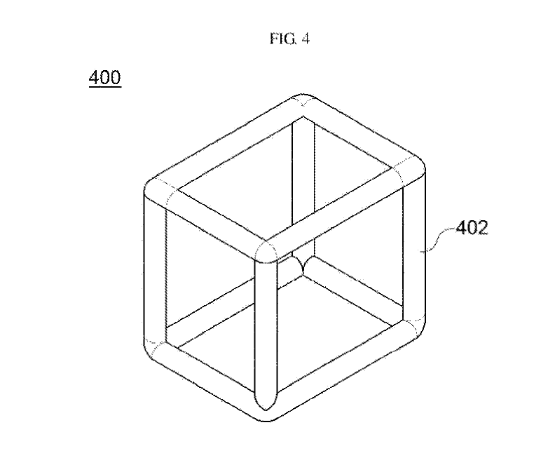

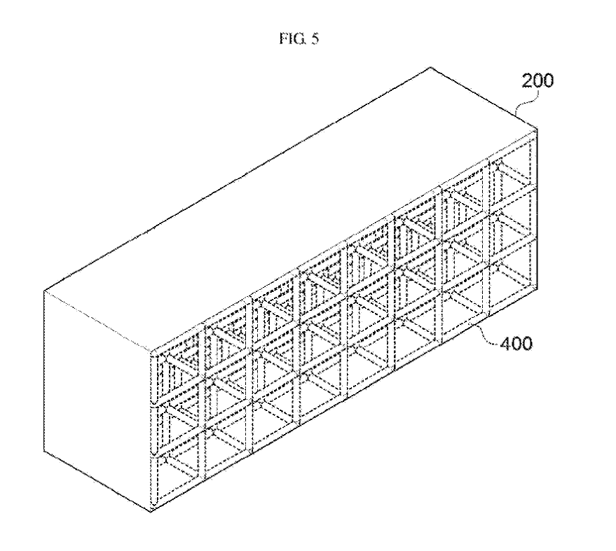

FIG. 4 is an exemplary diagram illustrating a 3D unit object according to an embodiment of the present disclosure. FIG. 5 is an exemplary diagram showing an example in which the 3D unit object shown in FIG. 4 is stacked inside the skinned 3D model shown in FIG. 3. In an embodiment of the present disclosure, the 3D unit object is a structure for replacing the interior of the 3D model and may be a frame structure to which one or more support members 402 are connected as shown. When the interior of the 3D model is replaced with the 3D unit object, it is possible to save the weight of the 3D object and the material cost for manufacturing the 3D object. In addition, by appropriately adjusting the thickness or the number of support members 402 constituting each 3D unit object, it is possible to form the 3D object to have the same or similar mechanical properties, compared to a 3D object having a solid structure, while reducing the weight and material cost of the 3D object.

A hexahedron 3D unit object is shown in FIG. 4, but it is merely illustrative. Accordingly, the shape of the 3D unit object may be various. For example, the 3D unit object may be formed in the shape of a polygonal prism such as a hexagonal prism and may have a form such as a rectangular tetrahedron. In other words, the 3D unit object may have any form as long as the form may be stackable. Embodiments of the present disclosure are not limited to the 3D unit object having a specific form.

According to an embodiment, the stacker 102 may stack the plurality of 3D unit objects such that adjacent 3D unit objects overlap by a predetermined distance or an outer wall of the skinned 3D model and a 3D unit object adjacent to the outer wall overlap by a predetermined distance.

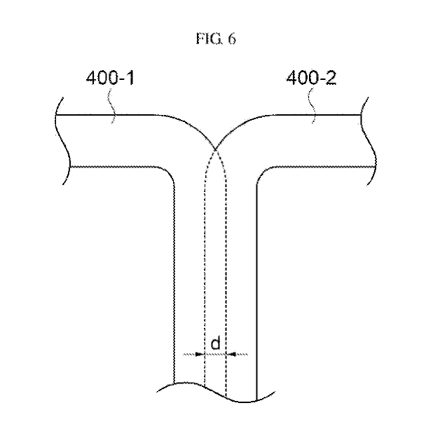

FIG. 6 is an exemplary diagram for describing an example in which the stacker 102 stacks adjacent 3D unit objects to overlap each other according to an embodiment of the present disclosure. As shown, a 3D unit object 400-1 and a 3D unit object 400-2, which are the adjacent 3D unit objects, may be stacked to overlap by a distance d. Here, the overlap distance d may be appropriately determined in consideration of the size, material, and structure of a 3D unit object or mechanical properties of a 3D object. Combination strength between 3D unit objects and mechanical properties of an entire 3D object vary depending on the overlap distance. According to an embodiment, the overlap distance d may be between 20% and 90% of a diameter of a support member constituting the 3D unit object.

Next, the influence calculator 104 calculates an influence of a change in a characteristic value of each of the plurality of 3D unit objects stacked inside the skinned 3D model on mechanical properties of the target 3D model.

According to an embodiment, the mechanical properties of the target 3D model may be any one of tensile strength, compressive strength, yield stress, elongation, fatigue strength, impact value, elasticity, heat transfer rate, thermal reliability, fatigue resistance, flow efficiency, and hardness of the 3D model. In addition, the characteristic value of the 3D unit object may be any one of a diameter of each support member constituting the 3D unit object, the number of support members formed in the 3D unit object, and a density of material of which the 3D unit object is made.

For example, the influence calculator 104 may calculate an influence of a change in the diameter of each support member constituting the 3D unit object on the tensile strength of the 3D model. Although the 3D unit object is stacked in the same way, the influence on the mechanical properties of the 3D model may vary depending on the position of the 3D unit object in the target 3D model. For example, a 3D unit object placed at a center of the 3D model may have a smaller influence on the mechanical properties of the 3D model than a 3D unit object adjacent to a surface of the 3D model.

Accordingly, it is possible to minimize the weight or the material cost of the 3D model and also to achieve the mechanical properties by maintaining the diameter of the support member of the 3D unit object having a low influence on the mechanical properties of the 3D model at the minimum level and appropriately adjusting the diameter of the support member of the 3D unit object having a relatively high influence.

According to an embodiment, the influence calculator 104 may obtain a simulation result of the change in the characteristic value of each 3D unit object using an experimental design method in which the characteristic value of the 3D unit object is utilized as a design variable. The experimental design method refers to a method of designing how an experiment is performed on a problem to be solved to acquire data and which statistical method is used to analyze data to obtain a maximum amount of information using a minimum number of experiments. For example, the influence calculator 104 may use the experimental design method such as single factor design, two-factor design, factorial design, fractional factorial design, split-plot design, confounding method, incomplete block design, response surface design, etc., to obtain the simulation result of the change in the characteristic value of the 3D unit object. In addition, according to an embodiment, the influence calculator 104 may use an optimal Latin hypercube design (OLHD) method as one of the experimental design methods to obtain the simulation result. The optimal Latin hypercube design (OLHD) method is a method of uniformly distributing sampling points in a single dimension of each design variable. This method is significantly advantageous for a deterministic computation experiment since the sampling points do not overlap one another for each design variable. In addition, this method may be easily implemented since the level of each design variable is arbitrarily determined, may be efficient when there are many factors, and may have a desired effect through a relatively small number of experiments. According to an embodiment of the present disclosure, the number of design variables may be equal to the number of 3D unit objects being stacked, and the number of sampling points may be three times the number of design variables or more.

Through the above-described experimental design method, in each case in which characteristic values are randomly assigned to the plurality of respective 3D unit objects, the influence calculator 104 may obtain an experiment result (simulation result) of the mechanical properties of the target 3D model. When the experiment result is obtained, the influence calculator 104 calculates an influence of a change in a characteristic value of each of the plurality of 3D unit objects on the mechanical properties of the target 3D model through a regression analysis for the simulation result. For example, the influence calculator 104 may be configured to calculate the influence through a linear regression analysis for the experiment result.

The grouper 106 groups the plurality of 3D unit objects into a plurality of groups according to the influence calculated by the influence calculator 104. According to an embodiment, the grouper 106 may normalize the influence into a value within a predetermined range (e.g., between 0 and 1) and may group the plurality of 3D unit objects into a plurality of groups according to the normalized influence. Here, the range of the influence for each group may vary depending on the number of groups. For example, when the plurality of 3D unit objects are grouped into five groups, the ranges of the influence corresponding to the respective groups are 0˜0.2, 0.2˜0.4, 0.4˜0.6, 0.6˜0.8, and 0.8˜1.0. In the case in which the 3D unit objects are grouped into 10 groups, that is, group 1 to group 10, Table 1 below illustrates the 3D unit objects belonging to the groups. In Table 1, it is assumed that the 3D unit objects are identified with respective assigned numbers.

TABLE 1

| Group | Influence | 3D unit object |
|---|---|---|
| 1 | 0~0.1 | 27, 33, 34, . . . |
| 2 | 0.1~0.2 | 13, 14, 15, . . . |
| 3 | 0.2~0.3 | 6, 7, 12, . . . |
| 4 | 0.3~0.4 | 5, 8, 9, . . . |
| 5 | 0.4~0.5 | 10, 52, 66, . . . |
| 6 | 0.5~0.6 | 4, 18, 51, . . . |
| 7 | 0.6~0.7 | 3, 65, . . . |
| 8 | 0.7~0.8 | 2, 17, 50, . . . |
| 9 | 0.8~0.9 | 49 |
| 10 | 0.9~1.0 | 1 |

Next, the characteristic value calculator 108 calculates an optimal characteristic value of the 3D unit object for each of the plurality of groups. According to an embodiment, in order to minimize the volume of the target 3D model while maintaining the mechanical properties of the target 3D model at a predetermined level or higher, the characteristic value calculator 108 may determine an optimal characteristic value of the 3D unit object for each of the plurality of groups. For example, in order to minimize the volume of the target 3D model while the tensile strength of the target 3D model satisfies a predetermined design condition, the characteristic value calculator 108 may determine the diameter of the support member of the 3D unit object for each group.

According to an embodiment, the characteristic value calculator 108 may determine the optimal characteristic value such that characteristic values of 3D unit objects belonging to the same group are the same. In general, the characteristic value calculator 108 finds an optimal point at which the mechanical properties of the target 3D model are satisfied and also the volume is minimized, by repeating simulation while sequentially changing the characteristic values (e.g., the thickness of the support member, etc.) of the 3D unit objects in the range between a minimum value and a maximum value. However, in general, the number of 3D unit objects stacked inside the 3D model is tens to hundreds. Accordingly, when the characteristic values of the 3D unit objects are individually changed, the number of simulations exponentially increases, and thus it is actually impossible to complete the simulations within an appropriate time period.

Accordingly, according to an embodiment of the present disclosure, the characteristic value calculator 108 determines the optimal characteristic value such that the characteristic values of the 3D unit objects are the same for each group classified according to the influence. In the above-described configuration, the number of variables for simulation is reduced to the number of groups, and thus the number of simulations for determining an optimal characteristic value is significantly reduced.

Table 2 below illustrates an example in which the characteristic value calculator 108 calculates an optimal characteristic value of a 3D unit object for each of the 10 groups disclosed in Table 1. In Table 2, the characteristic value calculator 108 calculates an optimal value of a diameter of a support member of each 3D unit object using 3 mm as an initial value in the range between the minimum value of 0.001 mm and the maximum value of 4 mm.

TABLE 2

| Group | Minimum | Initial | Optimal | Maximum | Unit |
|---|---|---|---|---|---|
| 1 | 0.0001 | 3 | 0.0001 | 4 | mm |
| 2 | 0.0001 | 3 | 1.14 | 4 | mm |
| 3 | 0.0001 | 3 | 2.56 | 4 | mm |
| 4 | 0.0001 | 3 | 3.32 | 4 | mm |
| 5 | 0.0001 | 3 | 4 | 4 | mm |
| 6 | 0.0001 | 3 | 4 | 4 | mm |
| 7 | 0.0001 | 3 | 4 | 4 | mm |
| 8 | 0.0001 | 3 | 4 | 4 | mm |
| 9 | 0.0001 | 3 | 4 | 4 | mm |
| 10 | 0.0001 | 3 | 4 | 4 | mm |
| Volume | | 22.8 * 10³ | 19.7 * 10³ | | mm³ |
| Max | | 0.79 | 0.80 | | mm |
| Displacement | | | | | |

As seen from Table 2, the volume of the 3D model is 22.8*10³ mm³ when the diameter of the support member of each group is fixed to 3 mm, and the volume of the 3D model is 19.7*10³ mm³ when the diameter of the support member has an optimal value. Thus, it can be seen that the volume is decreased by about 14% through the optimization. Since the decrease in volume is directly linked with the decrease in material cost as described above, the manufacturing cost of the 3D object may be effectively reduced through the optimization.

Furthermore, although the volume is decreased, the maximum displacement hardly changes (i.e., from 0.79 mm to 0.80 mm) when the 3D object is pulled. Accordingly, according to an embodiment of the present disclosure, it can be seen that it is possible to effectively maintain the desired mechanical properties while minimizing the volume of the model.

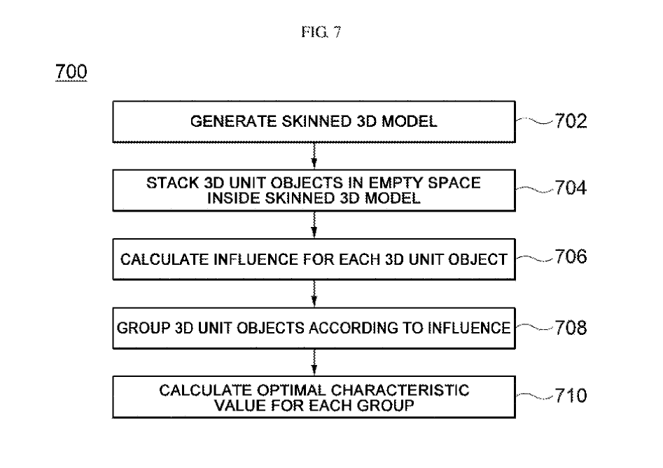

FIG. 7 is a flowchart for describing a method 700 of modeling a 3D shape according to an embodiment of the present disclosure.

In S702, a stacker 102 of an apparatus 100 for modeling a 3D shape generates a skinned 3D model by forming an empty space inside a target 3D model. Here, the stacker 102 may form the empty space by forming an outer wall with a predetermined thickness on the basis of an external surface of the target 3D model and deleting the interior of the outer wall.

In S704, the stacker 102 stacks a plurality of 3D unit objects in the empty space. As described above, the stacker 102 may stack the plurality of 3D unit objects such that adjacent 3D unit objects overlap by a predetermined distance or an outer wall of the skinned 3D model and a 3D unit object adjacent to the outer wall overlap by a predetermined distance.

In S706, the influence calculator 104 calculates an influence of a change in a characteristic value of each of the plurality of 3D unit objects on the mechanical properties of the target 3D model. In detail, the influence calculator 104 may obtain a simulation result of the change in the characteristic value of each 3D unit object using an experimental design method in which the characteristic value of the 3D unit object is utilized as a design variable and may calculate an influence on the mechanical properties of the target 3D model through a regression analysis for the simulation result. For example, the influence calculator 104 may obtain the simulation result using the optimal Latin hypercube design (OLHD) method.

In S708, the grouper 106 groups the plurality of 3D unit objects into a plurality of groups according to the influence. In detail, the grouper 106 may normalize the influence into a predetermined range and may group the plurality of 3D unit objects into the plurality of groups according to the normalized influence.

In S710, the characteristic value calculator 108 calculates an optimal characteristic value of the 3D unit object for each of the plurality of groups. The characteristic value calculator 108 may determine the optimal characteristic value such that characteristic values of 3D unit objects belonging to the same group are the same.

In detail, the characteristic value calculator 108 may determine the optimal characteristic value of the 3D unit object for each of the plurality of groups such that the volume of the target 3D model is minimized while the mechanical properties of the target 3D model are maintained at a predetermined level or higher.

Embodiments of the present disclosure may include a computer-readable recording medium including a program for performing methods described in this specification on a computer. The computer-readable recording medium may include a program instruction, a local data file, a local data structure, or a combination thereof. The medium may be designed and configured specifically for the present disclosure or can be typically available in the field of computer software. Examples of the computer-readable recording medium include a magnetic medium, such as a hard disk, a floppy disk, and a magnetic tape, an optical recording medium, such as a CD-ROM, a DVD, etc., a magneto-optical medium such as a floptical disk, and a hardware device specially configured to store and perform a program instruction, such as a ROM, a RAM, a flash memory, etc. Examples of the program instruction include a high-level language code executable by a computer with an interpreter, in addition to a machine language code made by a compiler.

According to embodiments of the present disclosure, it is possible to optimize an internal structure of a 3D model in consideration of mechanical properties of the 3D model, and also to effectively shorten a processing time for optimizing the internal structure of the 3D model.

Although exemplary embodiments of the disclosure has been described in detail, it will be understood by those skilled in the art that various changes may be made without departing from the spirit or scope of the disclosure. Thus, the scope of the present disclosure is to be determined by the following claims and their equivalents, and shall not be restricted or limited by the foregoing detailed description.

What is claimed is:

1. A method of modeling a three-dimensional (3D) shape, the method comprising:
generating a skinned 3D model by forming an empty space inside a target 3D model;
stacking a plurality of 3D unit objects in the empty space;
calculating an influence of a change in a characteristic value of each of the plurality of 3D unit objects on mechanical properties of the target 3D model;
grouping the plurality of 3D unit objects into a plurality of groups according to the calculated influence; and
calculating an optimal characteristic value of the 3D unit object for each of the plurality of groups.

2. The method of claim 1, wherein the generating of the skinned 3D model comprises forming the empty space by forming an outer wall with a predetermined thickness based on an external surface of the target 3D model and deleting an interior of the outer wall.

3. The method of claim 1, wherein the stacking comprises stacking the plurality of 3D unit objects such that adjacent 3D unit objects overlap by a predetermined distance or an outer wall of the skinned 3D model and a 3D unit object adjacent to the outer wall overlap by a predetermined distance.

4. The method of claim 1, wherein the calculating of the influence further comprises:
obtaining a simulation result of the change in the characteristic value of each 3D unit object using an experimental design method in which the characteristic value of the 3D unit object is utilized as a design variable; and
calculating an influence on the mechanical properties of the target 3D model through a regression analysis for the simulation result.

5. The method of claim 4, wherein the obtaining of the simulation result comprises using an optimal Latin hypercube design (OLHD) method to obtain the simulation result.

6. The method of claim 1, wherein the grouping comprises normalizing the influence into a predetermined range and grouping the plurality of 3D unit objects into the plurality of groups according to the normalized influence.

7. The method of claim 1, wherein the characteristic value of the 3D unit object is any one of a diameter of each object constituting the 3D unit object, the number of objects formed in the 3D unit object, and a density of material of which the 3D unit object is made.

8. The method of claim 1, wherein the calculating of the optimal characteristic value comprises determining the optimal characteristic value such that characteristic values of 3D unit objects belonging to the same group are the same.

9. The method of claim 8, wherein the calculating of the optimal characteristic value comprises determining the optimal characteristic value of the 3D unit object for each of the plurality of groups such that a volume of the target 3D model is minimized while the mechanical properties of the target 3D model are maintained at a predetermined level or higher.

10. A computer program stored in a recording medium that is combined with hardware and configured to execute a method, the method comprising:
generating a skinned 3D model by forming an empty space inside a target 3D model;
stacking a plurality of 3D unit objects in the empty space;
calculating an influence of a change in a characteristic value of each of the plurality of 3D unit objects on mechanical properties of the target 3D model;
grouping the plurality of 3D unit objects into a plurality of groups according to the calculated influence; and
calculating an optimal characteristic value of the 3D unit object for each of the plurality of groups.

11. An apparatus for modeling a three-dimensional (3D) shape, the apparatus comprising:
a stacker configured to generate a skinned 3D model by forming an empty space inside a target 3D model and stack a plurality of 3D unit objects in the empty space;
an influence calculator configured to calculate an influence of a change in a characteristic value of each of the plurality of 3D unit objects on mechanical properties of the target 3D model;
a grouper configured to group the plurality of 3D unit objects into a plurality of groups according to the calculated influence; and
a characteristic value calculator configured to determine an optimal characteristic value of the 3D unit object for each of the plurality of groups.

12. The apparatus of claim 11, wherein the stacker forms the empty space by forming an outer wall with a predetermined thickness based on an external surface of the target 3D model and deleting an interior of the outer wall.

13. The apparatus of claim 11, wherein the stacker stacks the plurality of 3D unit objects such that adjacent 3D unit objects overlap by a predetermined distance or an outer wall of the skinned 3D model and a 3D unit object adjacent to the outer wall overlap by a predetermined distance.

14. The apparatus of claim 11, wherein the influence calculator obtains a simulation result of the change in the characteristic value of each 3D unit object using an experimental design method in which the characteristic value of the 3D unit object is utilized as a design variable and calculates an influence on the mechanical properties of the target 3D model through a regression analysis for the simulation result.

15. The apparatus of claim 14, wherein the influence calculator uses an optimal Latin hypercube design (OLHD) method to obtain the simulation result.

16. The apparatus of claim 11, wherein the grouper normalizes the influence into a predetermined range and groups the plurality of 3D unit objects into the plurality of groups according to the normalized influence.

17. The apparatus of claim 11, wherein the characteristic value of the 3D unit object is any one of a diameter of each object constituting the 3D unit object, the number of objects formed in the 3D unit object, and a density of material of which the 3D unit object is made.

18. The apparatus of claim 11, wherein the characteristic value calculator determines the optimal characteristic value such that characteristic values of 3D unit objects belonging to the same group are the same.

19. The apparatus of claim 18, wherein the characteristic value calculator determines the optimal characteristic value of the 3D unit object for each of the plurality of groups such that a volume of the target 3D model is minimized while the mechanical properties of the target 3D model are maintained at a predetermined level or higher.
